(19) United States
(12) Patent Application Publication
(10) Pub. No.: US 2012/0240795 A1
(43) Pub. Date: Sep. 27, 2012

(54) Roller Bale Chute Accumulation

(75) Inventors: Kevin M. Tacke, Hesston, KS (US); Maynard M. Herron, Hesston, KS (US)

(73) Assignee: AGCO Corporation, Duluth, GA (US)

(21) Appl. No.: 13/337,507

(22) Filed: Dec. 27, 2011

Related U.S. Application Data
(60) Provisional application No. 61/427,579, filed on Dec. 28, 2010.

(51) Int. Cl. A01F 15/08; B30B 15/32

(52) U.S. Cl. 100/35; 100/218

(57) ABSTRACT

In an example embodiment, a roller bale chute accumulator apparatus includes a roller bale chute configured to receive a bale from a discharge opening of a baler and a bale drop mechanism configured to change the roller bale chute between a drop condition for dropping the bale from the roller bale chute and a non-drop condition for maintaining the bale on the roller bale chute. In one example embodiment the bale drop mechanism comprises a brake that is configured to manipulate a roller of the roller bale chute. In another example embodiment, a foldable bale chute portion is movable between a lower bale drop position and an upward non-drop position.

### CROSS-REFERENCE TO RELATED APPLICATION

Under provisions of 35 U.S.C. §119(e), Applicant claims the benefit of U.S. provisional application No. 61/427,579, filed Dec. 28, 2010, which is incorporated herein by reference.

### FIELD OF THE INVENTION

The present invention relates generally to crop baling machines of the type that pick up crop materials as the machine travels along the ground and then successively discharges formed bales onto the ground via a downwardly inclined bale discharge chute. More particularly, the invention relates to a way of controlling the drop of the bale from the chute so that the bale may be placed at a desired location in the field.

### BACKGROUND

When a roller bale chute is attached to a large square baler, the placement of the bales in the field is determined by the exit of the bale from the baler. Generally, after a bale is formed in a baling chamber, it is discharged through a discharge opening onto a bale chute so that it moves down the chute and drops to the ground. Such an arrangement tends to scatter the bales throughout the field in a manner that is inefficient for processing. It would be desirable to control the placement of the bale in the field to allow an operator to place bales at desired locations for efficient bale gathering. Although prior art bale accumulators have been constructed that attach in place of a roller bale chute, such arrangements are costly and do not work well in muddy fields.

### BRIEF DESCRIPTION OF THE DRAWINGS

FIG. 1 is a left side elevational view of an example embodiment of a baler constructed in accordance with the principles of the present invention showing a roller bale chute accumulator wherein a bale drop mechanism comprises a brake.

FIG. 2 is an enlarged, fragmentary, left rear perspective view of the baler of FIG. 1.

FIG. 3 is an enlarged, fragmentary, left side elevational view of the baler of FIG. 1.

FIG. 4 is a left side elevational view of an example embodiment of a baler constructed in accordance with the principles of the present invention showing a roller bale chute accumulator in which a bale drop mechanism comprises a foldable end section.

FIG. 5 is an enlarged, fragmentary, left rear perspective view of the baler of FIG. 4.

FIG. 6 is an enlarged, fragmentary, left side elevational view of the baler FIG. 4 in which the foldable section is in a drop condition.

FIG. 7 is an enlarged, fragmentary, left side elevational view of the baler FIG. 4 wherein the foldable section is in a non-drop condition.

FIG. 8 shows a bale drop system in accordance with an example embodiment of the invention.

FIG. 9 shows a user interface in accordance with an example embodiment of the invention.

FIG. 10A-B shows example bale drop arrangements.

### OVERVIEW

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, although the example embodiments are discussed in the context of a large square baler, the present invention may be used in other contexts as will become apparent to one of ordinary skill in the art.

In an example embodiment, a bale chute accumulator with drop control mechanism allows an operator to change the bale chute between a drop condition and a non-drop condition to allow on operator to place the bale in a desired location in the field. In one example embodiment, a roller chute accumulator includes a roller bale chute having one or more rollers and a brake configured to control the rotation of the one or more rollers in response to an operator input. For example, the operator may apply the brake to prevent a roller from rotating and thereby prevent a bale presently on the roller bale chute from dropping from the chute to the field. The operator may release the brake to allow the bale to drop from the roller bale chute at a desired field location.

In another example embodiment, a roller bale chute accumulator with drop control mechanism comprises a roller bale chute and a foldable roller portion that may be manipulated by an operator to move between a drop and a non-drop condition. For example, a foldable roller extension portion may be raised to a non-drop position to prevent a bale on the bale chute from dropping off the chute, and lowered to a drop position to allow the bale to drop from the chute.

### DETAILED DESCRIPTION OF EXAMPLE EMBODIMENTS

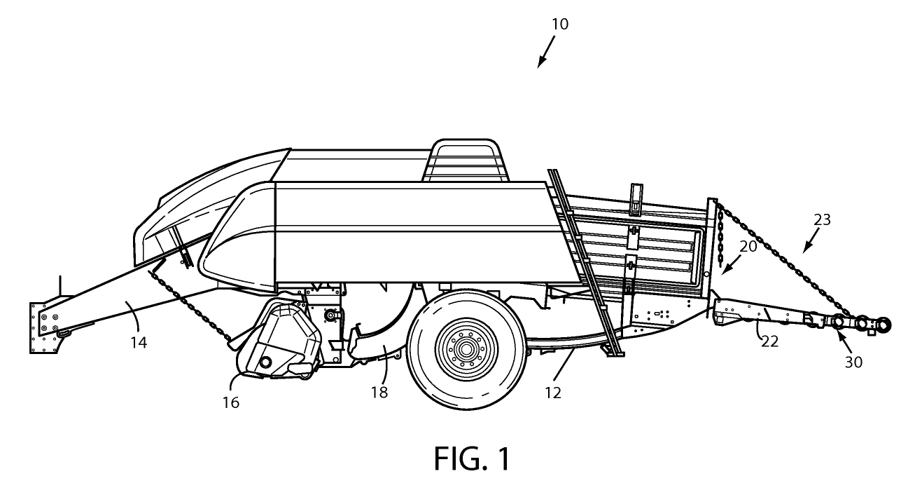

Referring initially to FIG. 1, a baler 10 is designed for producing “rectangular” bales in a manner understood by one of ordinary skill in the art. In the example embodiment, the baler 10 may be a large square baler as known in the art, such as AGCO large square baler, disclosed in U.S. Pat. No. 6,358,952, which is hereby incorporated by reference in its entirety herein, to the extent it does not conflict with the present disclosure.

The baler 10 has a wheeled chassis 12 that is provided with a tongue 14 at its front end for use in hitching the baler 10 to a towing tractor or the like (not shown). As the baler 10 advances across a field with windrowed crop materials lying thereon, a pickup 16 lifts the crop materials off the ground and delivers them rearwardly for compaction within an upwardly and rearwardly curved duct 18 leading upwardly to a fore-and-aft, slightly downwardly and rearwardly inclined baling chamber (not visible). A reciprocating plunger (not shown) within the baling chamber compresses charges of crop material from the duct 18 rearwardly within the baling chamber against previously compacted materials to progressively form a bale that incrementally moves rearwardly through the machine during each compaction stroke. In the illustrated embodiment, the baler 10 is an extrusion type baler, having a rear discharge opening 20 that has a reduced cross-sectional dimension relative to the upstream baling chamber so as to cause resistance to the rearward advance of bales within the machine, thus providing a type of moving backstop against which the plunger can operate to compress the materials. Before issuing from and through discharge opening 20, the bales may be wrapped by an appropriate mechanism (not shown) with a binding material to maintain the integrity of the bale after it has left the baler.

A generally downwardly and rearwardly inclined bale chute 22 of a bale discharge chute assembly 23 at the rear of the baler 10 accepts bales as they successively issue from the discharge opening 20 and guides them by gravity toward the ground. Preferably, the chute 22 is a roller type chute that minimizes the resistance to movement of the bales along and down the chute. A bale drop control mechanism 30 may be used to control the movement of the bale 40 from the chute 22 to the ground.

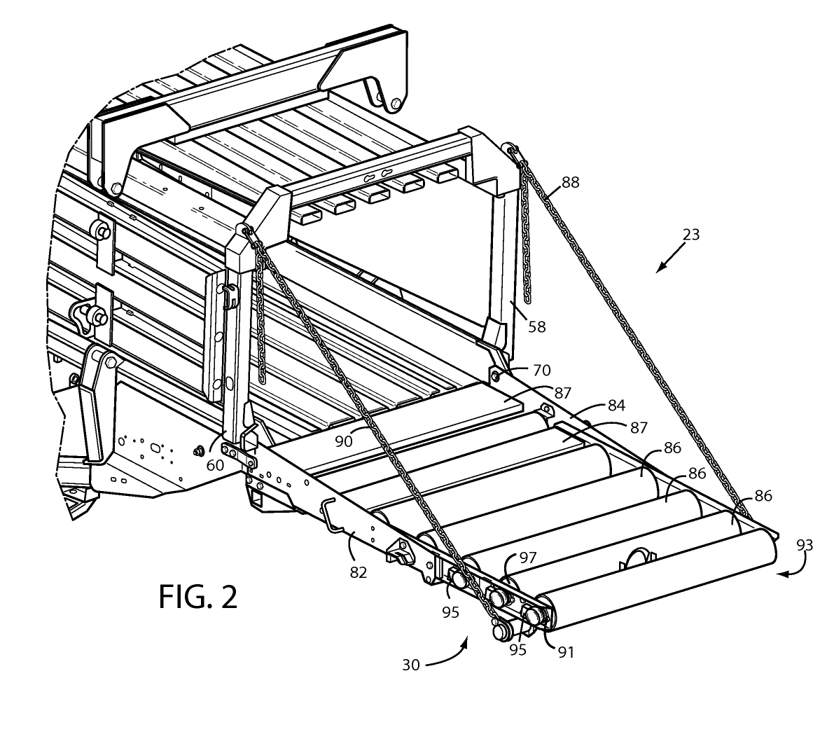

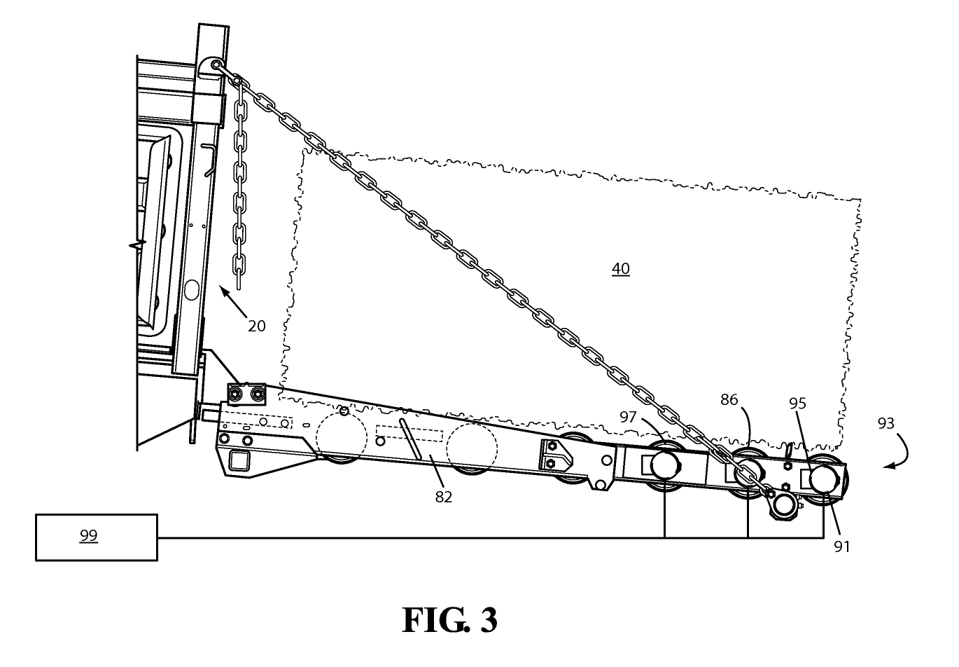

The chute 22 may be formed by a pair of laterally spaced apart, fore-and-aft extending side rails 82 and 84 (FIG. 2) and a plurality of transverse anti-friction rollers 86 and non-rotatable plates 87. The discharge chute assembly 23 may further include a pair of tension elements in the form of link chains 88 and 90 that are connected between the outer end portion of chute 22 and upper end portions of the respective upright members 58, 60 of the baler frame. The chute 22 is biased yieldably downwardly by gravity such that chains 88, 90 limit the downswing of the chute 22 about pivot bolts 70, the selected downwardly inclined position of chute 22 thus establishing its lowered, discharge position.

The rollers 86 may rotatably mounted in bearing assemblies 91 so that a bale 40 may move over the rollers 86 to drop off an end 93 of the chute to the ground. The bale drop mechanism 30 may comprise one or more brakes 95 configured to manipulate the rotation of the rollers 86. In an example embodiment, the brakes 95 may comprise an expandable mandrel type brake commonly used for braking a roller and configured for contacting and applying friction to the inner core 97 of the roller. A user interface 99, such as a control lever, input display, or the like, may be provided in the cab of a tow vehicle (not shown) and used by the operator to apply or release the brake 95. Thus, an operator can apply resistance to the roller and slow or stop movement of the bale along the chute 22 by applying the brake 95. The operator can then drop the bale in a desired location in the field. For example, the operator could apply increased resistance at a center of the field and apply little or no resistance near the ends of the field so that bales are held on the chute at the field center and drop off the chute near the ends of the field. This allows for easier pickup of the bales.

The brake 95 may be a mechanical and hydraulic system or an electromechanical system as known in the art and operable by an operator in a cab of a two vehicle. For example, in an mechanical system a lever (not shown) may be provided in a tow vehicle for actuation of a hydraulic brake such as a operating a brake caliper to make contact with a rotor associated with a roller 86 or to expand a mandrel to contact an inner surface of a roller core. In an electromechanical system, a button, switch or the like may be provided in the cab of a tow vehicle and configured to actuate an actuator via a CAN bus or other communications link. For example, a button may be provided to actuate a solenoid on an expandable mandrel brake. Other arrangements could also be provided as will become apparent to one of ordinary skill in the art.

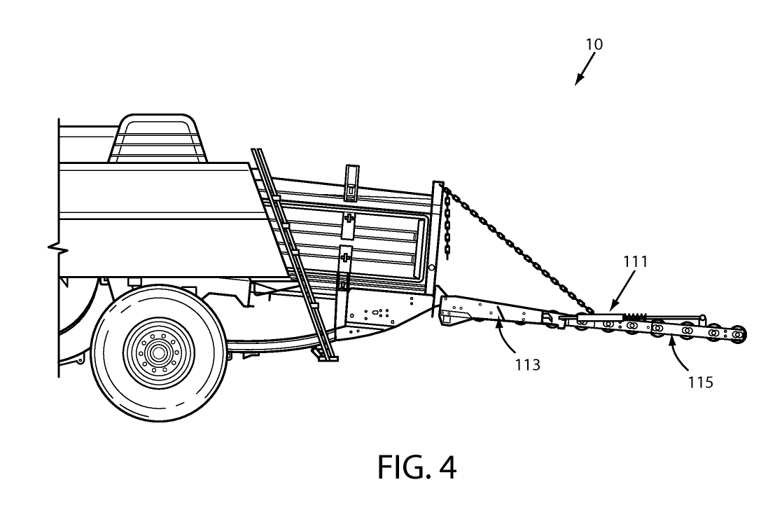

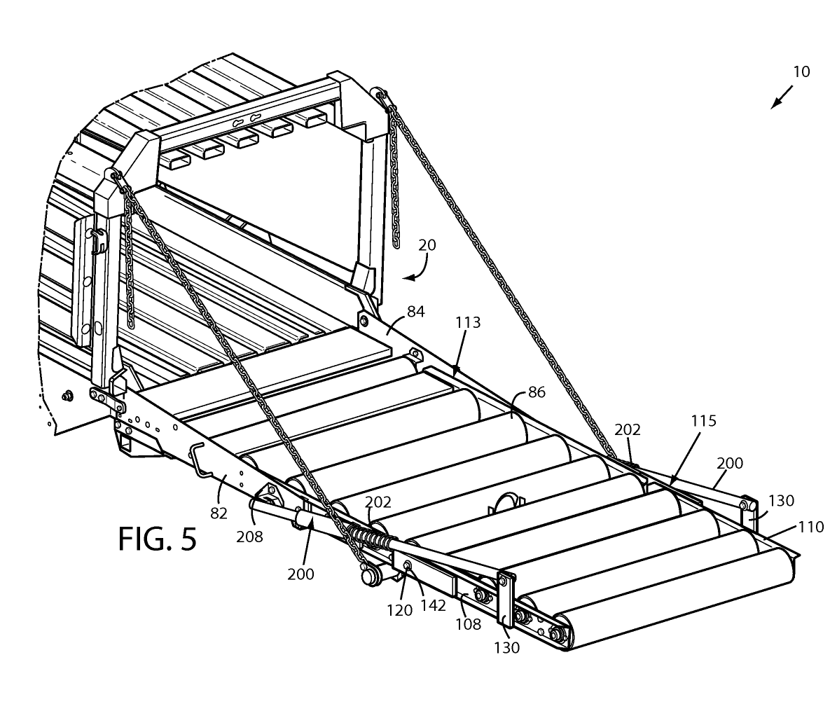

FIGS. 4-7 show another example embodiment of a baler with a bale drop mechanism 30. In that example embodiment, the baler 10 is similar to the baler of FIG. 1 and the bale drop mechanism 30 comprises a roller chute 111 having a stationary portion 113 and a foldable portion 115. The foldable portion 115 may be moved between a downward drop condition in which the foldable portion extends to form a path for the bale to roll off the chute and an upward non-drop condition in which the foldable portion 115 blocks the bale from dropping from the chute. By manipulating the foldable portion between a drop and non-drop condition, the operator can drop a bale at a desired location. In the downward position the foldable portion serves as an extension to the stationary portion and provides a path form the bale to drop to the field.

The structure of the foldable portion 115 may be similar to the stationary portion and serve as an extension thereof when in the down position. The stationary portion 113 can be similar to that of a standard bale chute 22 discussed above and include side rails 108, 110 and rollers 86 rotatably mounted thereon by bearing assemblies 91. The side rails 108, 110 of the foldable portion 115 generally align with the side rails 82, 84 of the stationary portion 113. The foldable portion 115 may be coupled to the stationary portion 113 at a pivot point 120, such as pivot bolts 142, about which the foldable portion 115 rotates.

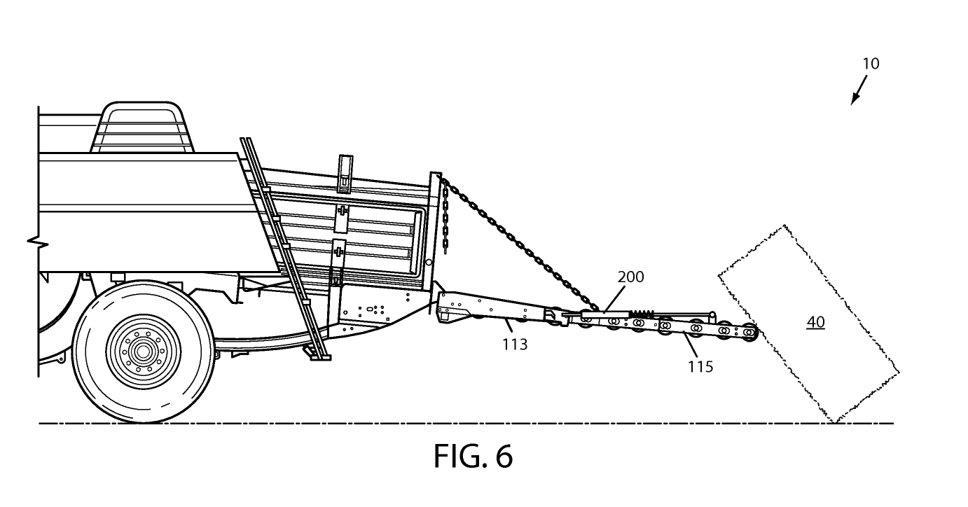

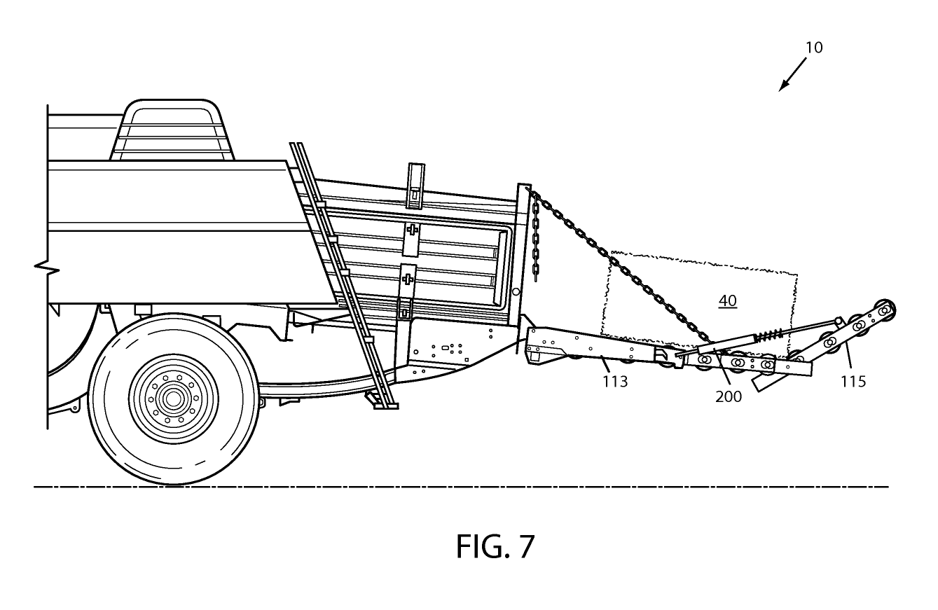

An extendable member may extend between the stationary portion 113 and the foldable portion 115 so that extension and retraction of the extendable member can lower and raise the foldable portion 115. Any suitable extendable member could be used such as a hydraulic cylinder or linear actuator as know in the art that may be powered by hydraulic, electro-mechanical or other means. In an example embodiment, a linear actuator 200 and a spring 202 may extend between a mount 208 on the stationary portion 113 and a mounting flange 130 extending upward from the foldable portion. This arrangement allows the foldable portion to be moved between an up non-drop position and a down drop position. For example, as seen in FIG. 6, with the linear actuator 200 in the extended condition, the foldable portion 115 is in a downward position and generally aligned with the stationary portion 113 to provide a rollable pathway for the bale. A bale exiting the discharge opening 20 is received on the stationary portion 113 and continues across the foldable portion 115 and drops to the field. When the linear actuator 200 is in a retracted condition as shown in FIG. 7, then the foldable portion 115 is in a an upward position that blocks the bale 40 from being dropped to the ground.

The spring 202 may have a spring constant to provide a sufficient resilient force to keep a bale sitting on the bale chute from dropping to the ground but allowing the foldable portion 115 to be pushed downward to a drop position if needed. For example, the spring constant should be such that if the operator leaves the foldable portion 115 in an up position and another bale 40 is extruding from the baling chamber contacts and pushes against the first bale, then this force is sufficient to move the foldable portion 115 downward to a drop condition and allow the first bale to drop from the chute.

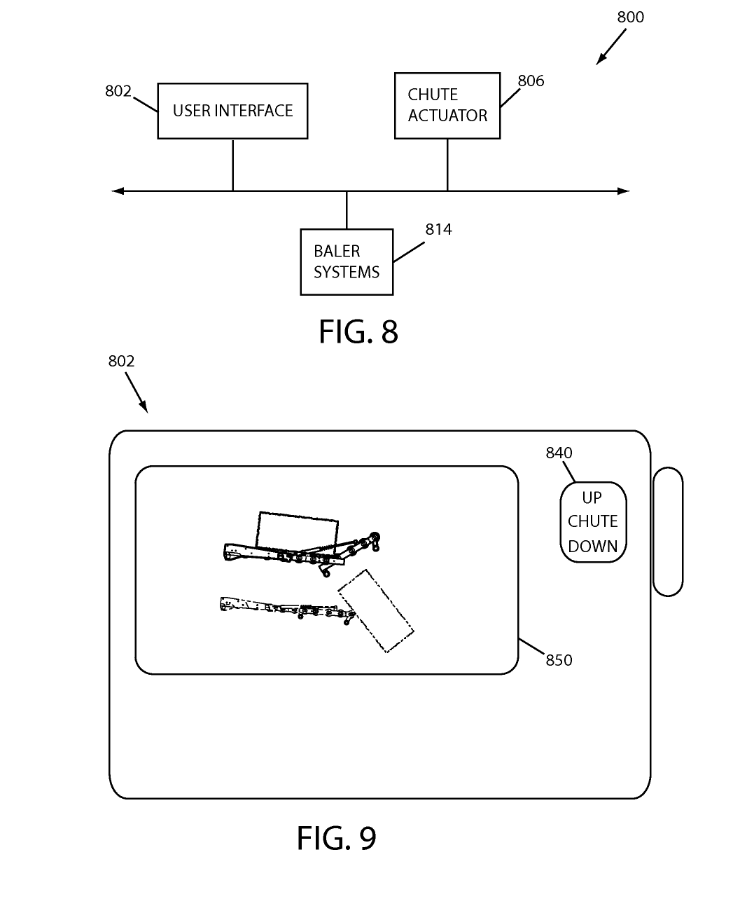

FIG. 8 shows an example system 800 of the invention, in which a user interface 802 is communicatively coupled to an actuator 806 via a CAN bus. Other systems 814 of the baler may also communicate over the CAN bus. The actuator 806 is configured to convert the bale chute to a non-drop condition as discussed above. For example, as discussed above, the actuator may be a solenoid or other device that actuates a brake or a linear actuator to manipulate a bale chute.

FIG. 9 shows an example embodiment of a user interface 802 for use with the foldable chute embodiment in which a toggle switch 840 is provided to send either an up signal or down signal to an actuator 806 to raise or lower the foldable portion 115. A display 850 may be used to indicate the present status of the foldable portion by highlighting the present state of the foldable portion 115. Although the user interface 802 is shown as a separate component its functions could be incorporated into a larger interface, such as a main baler interface of the baler systems 814.

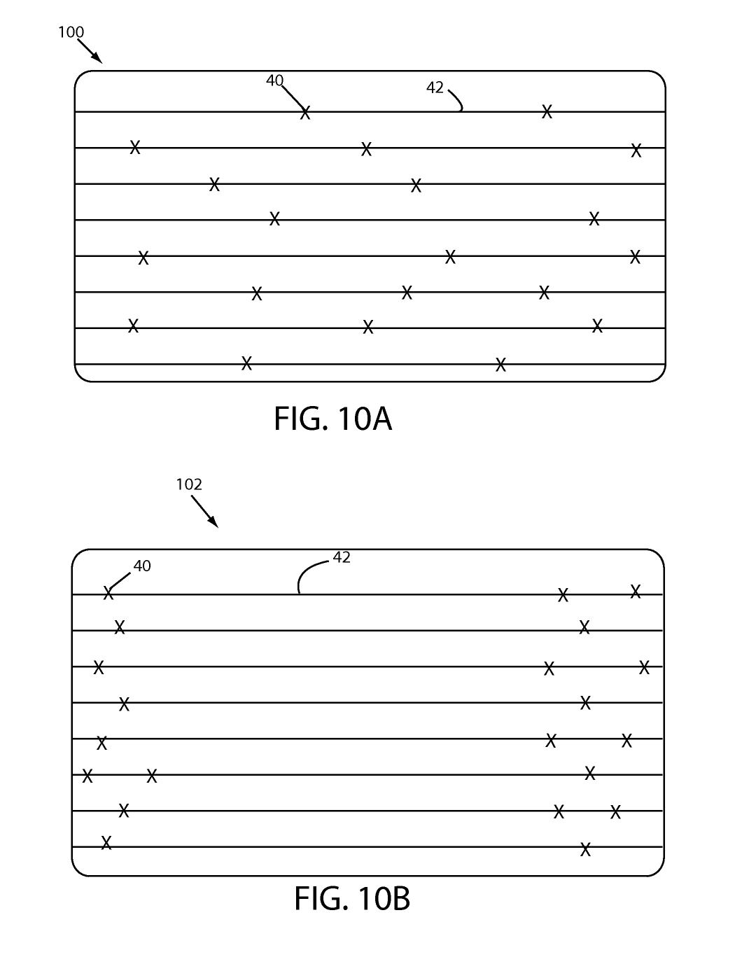

FIG. 10A shows a typical prior art drop arrangement 100 in which bales 40 are scattered about the field along the rows 42 of travel. FIG. 10B shows an example of a bale drop arrangement 102 that may be accomplished by the present invention in which bales 40 are accumulated near row ends. As the baler 10 is moved along a row, an operator may place the roller bale chute in a non-drop condition when in the middle of the row and in a drop position when at the end of a row. This allows an operator to drop bales 40 at row ends for easy collection.

What is claimed is:

1. A roller bale chute accumulator apparatus, comprising:
a roller bale chute configured to receive a bale from a discharge opening of a baler; and
a bale drop mechanism configured to change the roller bale chute between a drop condition to drop the bale from the roller bale chute and a non-drop condition to maintain the bale on the roller bale chute.

2. The roller bale chute accumulator of claim 1, wherein the roller bale chute comprises at least one roller for receiving the bale thereon and the bale drop mechanism comprises a brake for manipulating rotation of the at least one roller.

3. The roller bale chute accumulator of claim 2, wherein the brake comprises an expandable mandrel brake.

4. The roller bale chute accumulator of claim 1, further comprising a user interface accessible by an operator, the user interface configured to control operation of the brake.

5. The roller bale chute accumulator of claim 1, wherein the bale drop mechanism comprises a foldable bale chute portion configured for movement between a bale drop position and a non-drop position.

6. The roller bale chute accumulator of claim 5, further comprising a user interface accessible by an operator, the user interface configured to actuate the foldable bale chute portion.

7. The roller bale chute accumulator of claim 5, wherein the foldable bale chute portion comprises a bale chute having at least one roller and an extendable member configured to rotate the foldable bale chute portion about a pivot point.

8. The roller bale chute accumulator of claim 5 wherein the foldable bale chute portion further comprises a spring coupled to the extendable member.

9. The roller bale chute accumulator of claim 8, wherein the spring has a spring constant such that the foldable bale chute portion may be folded downward by force of an extruding bale.

10. The roller bale chute of claim 8, wherein the extendable member is a linear actuator.

11. The roller bale chute of claim 8, wherein the extendable member is a hydraulic cylinder.

12. A mobile baler having a discharge opening through which bales issue as the baler travels along the ground, comprising:
a baling chamber configured to form a bale;
a discharge opening through which the bale is discharged;
a roller bale chute assembly configured to receive the bale from the discharge opening and transport the bale to the ground;
a bale drop mechanism configured to change the roller bale chute assembly between a bale drop condition and a non-drop condition.

13. The mobile baler accumulator of claim 12, wherein the roller bale chute comprises at least one roller for receiving the bale thereon and the bale drop mechanism comprises a brake for manipulating rotation of the at least one roller.

14. The mobile baler of claim 13, wherein the brake comprises an expandable mandrel brake.

15. The mobile baler of claim 13, further comprising a user interface accessible by an operator, the user interface configured to control operation of the brake.

16. The mobile baler of claim 12, wherein the bale drop mechanism comprises a foldable bale chute portion configured for movement between a bale drop position and a non-drop position.

17. The mobile baler of claim 16, further comprising a user interface accessible by an operator, the user interface configured to actuate the foldable bale chute portion.

18. A method, comprising:
forming a bale in a baling chamber of a baler;
discharging the bale through a discharge opening of the baler to a roller bale chute; and
placing the bale chute in a non-drop condition to maintain the bale on the roller bale chute.

19. The method of claim 18, further comprising:
placing the roller bale chute in a drop condition to drop the bale from the roller bale chute.

20. The method of claim 18, wherein said placing the roller bale chute in a non-drop condition to maintain the bale on the roller bale chute comprises braking a roller of the roller bale chute to prevent rotation of a roller of the roller bale chute.

21. The method of claim 18, wherein said placing the roller bale chute in a non-drop condition to maintain the bale on the roller bale chute comprises moving a portion of the roller bale chute to a non-drop position.

22. The method of claim 19 wherein said step of placing the roller bale chute in a drop condition to drop the bale from the roller bale chute comprises releasing a roller brake.
